(19) United States
(12) Patent Application Publication
(10) Pub. No.: US 2005/0236246 A1
(43) Pub. Date: Oct. 27, 2005

(54) Secondary driven axle control

(75) Inventor: Mark A. Joki, Dover, OH (US)

Correspondence Address: MICHAEL BEST & FRIEDRICH, LLP, 100 E WISCONSIN AVENUE, MILWAUKEE, WI, 53202, US

(73) Assignee: Timken US Corporation, Torrington, CT (US)

(21) Appl. No.: 11/111,117

(22) Filed: Apr. 21, 2005

Related U.S. Application Data
(60) Provisional application No. 60/564,046, filed on Apr. 21, 2004.

(51) Int. Cl. F16D 41/00; F16H 48/12

(52) U.S. Cl. 192/35; 192/38; 74/650

(57) ABSTRACT

A clutch assembly is provided for a vehicle having at least one primary driven axle supporting a first wheel and at least one secondary driven axle supporting a second wheel. The at least one primary driven axle is driven by a vehicle transmission. The clutch assembly includes a clutch movable between a first position, wherein the transmission engages the at least one secondary driven axle when the first wheel slips and disengages the at least one secondary driven axle when the first wheel does not slip, and a second position, wherein the at least one secondary driven axle engages the transmission to provide engine braking. A single actuator is operable to move the clutch between the first and second positions.

### RELATED APPLICATIONS

This application claims priority to U.S. Provisional Patent Application Ser. No. 60/564,046 filed Apr. 21, 2004, the entire contents of which are hereby incorporated by reference.

### BACKGROUND

The present invention relates to a clutch for a vehicle having primary driven axles and secondary driven axles. More particularly, the present invention relates to an electrically actuated bi-directional roller clutch for controlling overriding engagement of the secondary driven axles.

In a four wheel drive system for an all terrain vehicle, overrunning clutches allow a secondary driven axle to freewheel when the primary axle wheels have good traction and drive when the primary axle wheels slip. However, the overrunning clutches freewheel in downhill operation. It is advantageous for the auxiliary axle to also contribute to engine braking or negative drive torque. U.S. Pat. No. 5,971,123 with reissue RE38,012 deals with this situation by having two or more coils or actuators to control an overrunning clutch.

### SUMMARY

The present invention provides an overrunning clutch assembly that includes a single actuator capable of controlling the overrunning clutch both to engage the secondary axles during wheel slip at the primary axles, and to engage the secondary axles to contribute to engine braking. By incorporating a single actuator, the design of the overrunning clutch assembly is simplified and the overall cost is reduced.

In one embodiment, the invention provides a clutch assembly for a vehicle having at least one primary driven axle supporting a first wheel and at least one secondary driven axle supporting a second wheel. The at least one primary driven axle is driven by a vehicle transmission. The clutch assembly includes a clutch movable between a first position, wherein the transmission engages the at least one secondary driven axle when the first wheel slips and disengages the at least one secondary driven axle when the first wheel does not slip, and a second position, wherein the at least one secondary driven axle engages the transmission to provide engine braking. A single actuator is operable to move the clutch between the first and second positions.

In another embodiment, the invention provides a clutch assembly for a vehicle having at least one primary driven axle supporting a first wheel and at least one secondary driven axle supporting a second wheel. The at least one primary driven axle is driven by a vehicle transmission. The clutch assembly includes a clutch movable between a first position, wherein the transmission engages the at least one secondary driven axle when the first wheel slips and disengages the at least one secondary driven axle when the first wheel does not slip, and a second position, wherein the at least one secondary driven axle engages the transmission to provide engine braking. The clutch assembly further includes an actuator having first and second conditions. The actuator has a plate coupled with the at least one secondary driven axle. The plate is free to rotate with the at least one secondary driven axle to move the clutch to one of the first and second positions when the actuator is in the first condition, and the plate is substantially prevented from rotating with the at least one secondary driven axle to move the clutch to the other of the first and second positions when the actuator is in the second condition.

In a further embodiment, the present invention provides a clutch assembly for a vehicle having at least one primary driven axle and at least one secondary driven axle with the at least one primary driven axle driven by a vehicle transmission. The clutch assembly comprises a drive sleeve having an inner surface engaging the secondary driven axle and an outer surface supporting a clutch inner race. A carrier associated with and driven by the vehicle transmission has an inner surface supporting a clutch outer race aligned with the clutch inner race. The clutch outer race has spaced apart inwardly extending ridges that define a series of roller pockets. A plurality of rollers are positioned in respective ones of the roller pockets between the clutch inner and outer races. A cage rotationally supported between the clutch inner and outer races includes a plurality of fingers extending between the clutch inner and outer races such that at least one finger extends between each pair of adjacent rollers. A brake plate is rotationally supported by the drive sleeve and a solenoid armature selectively engages the brake plate to prevent rotation thereof. A friction plate is rotationally supported by the drive sleeve and rotationally engages the cage. The friction plate has a first friction pad of a first diameter engaging the clutch inner race and a second friction pad of a second diameter larger than the first diameter engaging the brake plate.

### BRIEF DESCRIPTION OF THE DRAWINGS

FIG. 1 is a schematic representation of one drive train embodiment in a vehicle incorporating the present invention.

FIG. 2 is a partial sectional view of an axle center embodying this invention.

FIG. 3 is a partial isometric view of the cage and friction plate.

FIG. 4 is a schematic diagram showing the clutch in overrunning mode.

FIG. 5 is a schematic diagram showing the clutch in lock mode.

FIG. 6 is a schematic diagram showing the clutch in brake lock mode.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

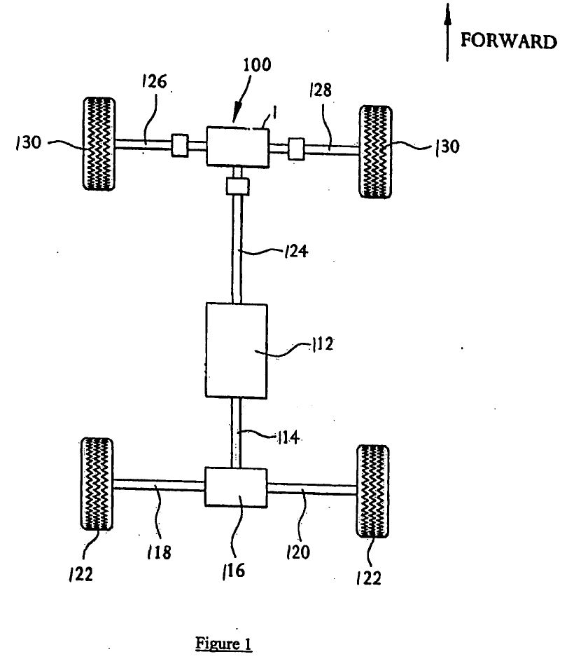

Referring to FIG. 1, a schematic representation of one embodiment of a drive system incorporating a bidirectional overrunning clutch assembly 100 according to the present invention is shown. The drive system includes a transmission 112, a primary drive shaft 114, a primary differential 116, and first and second primary driven shafts 118, 120 which drive primary wheels 122.

The drive system also includes a secondary drive shaft 124 which is rotatably connected to the bidirectional overrunning clutch assembly 100 through any conventional means known to those skilled in the art, such as a splined connection. The overrunning clutch assembly 100, in turn, rotatably drives two secondary driven shafts 126, 128 which are attached to wheels 130. The overrunning clutch assembly 100 includes a housing 1 supported by the vehicle.

The details of the bi-directional overrunning clutch assembly 100 will now be described with respect to FIGS. 2-6. Referring to FIG. 2, a carrier 2 is supported by bearings (not shown) within housing 1. The carrier 2 is connected to and driven by the secondary drive shaft 124 in a conventional manner. The overrunning clutch assembly 100 includes two clutch mechanisms, one for each secondary driven shaft 126, 128. Each clutch mechanism includes a drive sleeve 3 configured to engage the respective secondary driven shaft 126, 128 which in turn is attached to a respective vehicle wheel 130. For simplification, only one drive sleeve 3 and associated components of the clutch mechanism is shown in FIG. 2. The other drive sleeve 3 and associated components of the clutch mechanism is a mirror image of that shown and is also associated with the carrier 2 in a similar manner as that described below.

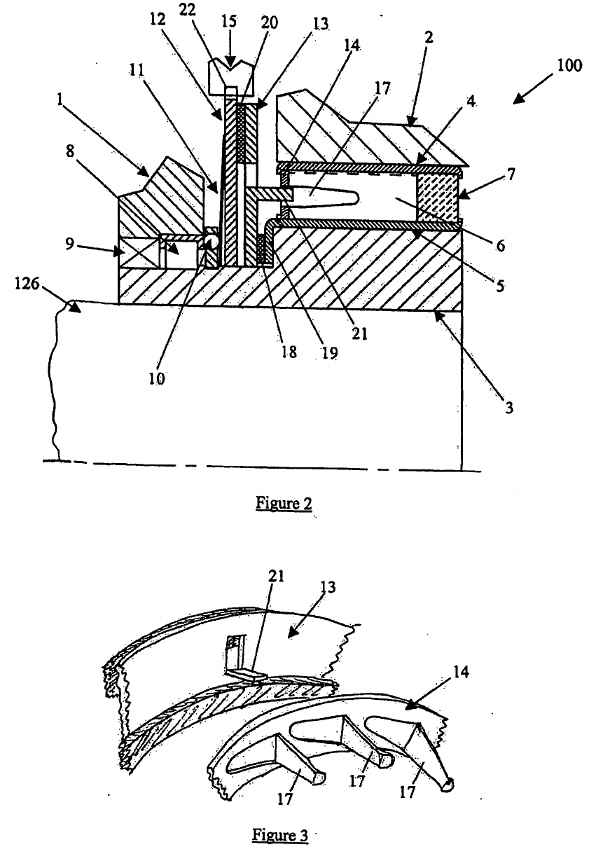

The drive sleeve 3 is radially supported by a bushing 7 and a roller bearing 8. Into the inner periphery of the carrier 2 is fit a clutch outer race 4. Onto the outer periphery of the drive sleeve 3 is fit a clutch inner race 5. Onto the inner periphery of the outer race 4 is formed a multiplicity of longitudinal ridges 16 which form pockets into which rollers 6 are placed. Between each roller 6 is located the spring finger 17 of the cage 14. A friction plate 13 rotatably supported by the drive sleeve 3 has a small diameter, generally annular friction pad 18 in contact with a flange 19 on the inner race 5, a large diameter, generally annular friction pad 20 in contact with the brake plate 12, and a projection 21 which rotationally engages the cage 14. FIG. 3 illustrates the cage 14 and friction plate 13. Referring back to FIG. 2, the brake plate 12 is rotatably supported by the drive sleeve 3 and has projections 22 on an outer periphery which can be rotationally blocked by the armature of a solenoid 15. In the illustrated embodiment, the armature of the solenoid 15 is spring loaded such that its deenergized state is to engage projections 22 and block the rotation of the brake plate 12. A disk spring 11 maintains an axial force against both friction pads 18, 20 of the friction plate 13. A thrust bearing 10 allows transmission of axial force with low friction. A seal 9 encloses the bearing 10.

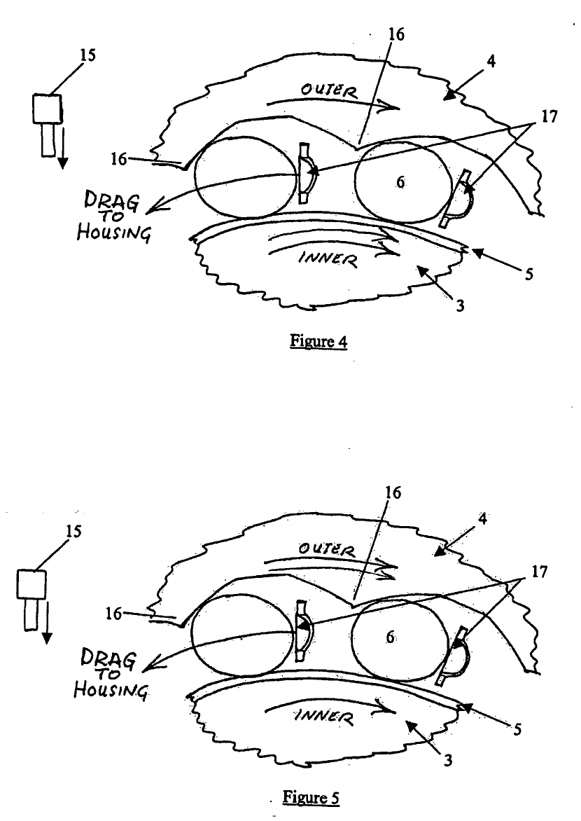

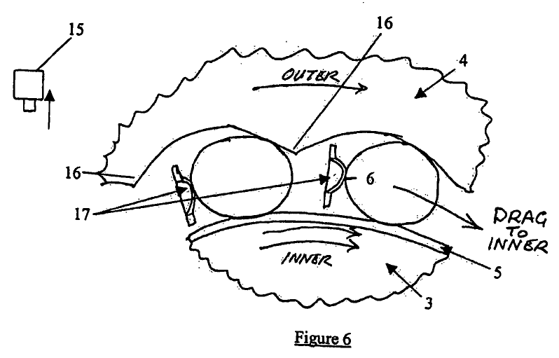

Referring to FIGS. 2, 4 and 5, the armature of the solenoid 15 is deenergized such that it is preventing the brake plate 12 from rotating. The non-rotating brake plate 12 causes drag torque on the larger diameter friction pad 20 of the friction plate 13, this drag torque being greater than that of the smaller diameter pad 18 because of the diameter difference. As a result, with the armature of the solenoid 15 deenergized, a net drag torque opposing the rotation of the carrier 2 is created and the projection 21 of friction plate 13 engages the cage 14, causing the fingers 17 to apply force in a counterclockwise direction to rollers 6 (see FIGS. 4 and 5). With good traction at the primary axle, the secondary axle wheels 130 travel faster due to a higher drive ratio which results in a relative clockwise rotation of the drive sleeve 3 (as indicated by the double arrows in FIG. 4). The rollers 6 being forced counterclockwise, allow the drive sleeve 3 and inner race 5 to slip. This is an overrunning condition when there is good traction. In this overrunning condition, the transmission 112 does not drivingly engage or transmit power to the axle 126. When traction is poor, the drive sleeve 3 and inner race 5 attempt to run slower than the carrier (as indicated by the double arrows in FIG. 5) which is a relative counterclockwise rotation of the drive sleeve 3 and inner race 5. Since the cage 14 is holding the rollers 6 counterclockwise into contact with both the inner and outer races 5 and 4, the shallow, three to six degree angle wedge formed between the tangent lines of the points of contact at the outer race 4 and inner race 5, the rollers 6 lock with high force and the carrier 2 drives the axle 126. This results in the transmission 112 drivingly engaging and transmitting power to the axle 126. The same function occurs in reverse rotation.

Referring to FIGS. 2 and 6, the vehicle is now traveling downhill and engine braking is desired. The control system energizes the solenoid 15, causing the armature to move upwardly from the position illustrated in FIG. 2 to disengage the projections 22 on the brake plate 12, thereby allowing the brake plate 12 to rotate due to the frictional contact with the friction plate 13. The friction between the small diameter pad 18 on the friction plate 13 and the flange 19 on the inner race 5 remains, causing the drag force illustrated in FIG. 6, and causing the friction plate 13, and thereby the cage 14, to try to rotate with the drive sleeve 3. As a result, the cage fingers 17 are pushing the rollers 6 clockwise and there is a clockwise movement of the drive sleeve 3 relative to the outer race 4 (as indicated by the double arrows in FIG. 6). The rollers 6 lock and the axle 126 now drives the carrier 2 for engine braking. In other words, the axle 126 engages with the transmission 112, resulting in engine braking. The same function occurs in reverse rotation.

Various features of the invention are set forth in the following claims.

1. A clutch assembly for a vehicle having at least one primary driven axle supporting a first wheel and at least one secondary driven axle supporting a second wheel, the at least one primary driven axle driven by a vehicle transmission, the clutch assembly comprising:
a clutch movable between a first position, wherein the transmission engages the at least one secondary driven axle when the first wheel slips and disengages the at least one secondary driven axle when the first wheel does not slip, and a second position, wherein the at least one secondary driven axle engages the transmission to provide engine braking; and
a single actuator operable to move the clutch between the first and second positions.

2. The clutch assembly of claim 1, wherein the single actuator includes a single solenoid.

3. The clutch assembly of claim 1, wherein the single actuator has a first condition and a second condition, and wherein the actuator includes a plate coupled with the at least one secondary driven axle, the plate being free to rotate with the at least one secondary driven axle to move the clutch to one of the first and second positions when the actuator is in the first condition, and the plate being substantially prevented from rotating with the at least one secondary driven axle to move the clutch to the other of the first and second positions when the actuator is in the second condition.

4. The clutch assembly of claim 3, wherein the plate is a first plate and wherein the actuator further includes:
a second plate in frictional engagement with the first plate; and
wherein the clutch assembly further includes,
a drive sleeve having an inner surface engaging the at least one secondary driven axle and an outer surface supporting a clutch inner race;
a carrier associated with and driven by the transmission, the carrier having an inner surface supporting a clutch outer race aligned with the clutch inner race, the clutch outer race having spaced apart ridges that define a series of roller pockets;
a plurality of rollers positioned in the respective roller pockets between the clutch inner and outer races; and
a cage rotationally supported between the clutch inner and outer races, the cage including a plurality of fingers extending between the clutch inner and outer races such that at least one finger extends between adjacent rollers;
wherein the second plate includes a projection that engages the carrier to selectively move the plurality of fingers and thereby shift the rollers within the respective roller pockets to achieve the first and second clutch positions.

5. The clutch assembly of claim 4, wherein the second plate includes a first friction pad engaging the first plate and a second friction pad engaging the clutch inner race.

6. The clutch assembly of claim 5, wherein the first and second friction pads are generally annular and have different diameters.

7. The clutch assembly of claim 4, wherein the second plate is sandwiched between the first plate and the clutch inner race.

8. The clutch assembly of claim 3, wherein the single actuator further includes a solenoid, the solenoid being energized to place the actuator in the first condition and the solenoid being deenergized to place the actuator in the second condition.

9. A clutch assembly for a vehicle having at least one primary driven axle supporting a first wheel and at least one secondary driven axle supporting a second wheel, the at least one primary driven axle driven by a vehicle transmission, the clutch assembly comprising:
a clutch movable between a first position, wherein the transmission engages the at least one secondary driven axle when the first wheel slips and disengages the at least one secondary driven axle when the first wheel does not slip, and a second position, wherein the at least one secondary driven axle engages the transmission to provide engine braking; and
an actuator having first and second conditions, the actuator having a plate coupled with the at least one secondary driven axle, the plate being free to rotate with the at least one secondary driven axle to move the clutch to one of the first and second positions when the actuator is in the first condition, and the plate being substantially prevented from rotating with the at least one secondary driven axle to move the clutch to the other of the first and second positions when the actuator is in the second condition.

10. The clutch assembly of claim 9, wherein the actuator includes a single solenoid.

11. The clutch assembly of claim 10, wherein the solenoid is energized to place the actuator in the first condition and the solenoid is deenergized to place the actuator in the second condition.

12. The clutch assembly of claim 9, wherein the plate is a first plate and wherein the actuator further includes:
a second plate in frictional engagement with the first plate; and
wherein the clutch assembly further includes,
a drive sleeve having an inner surface engaging the at least one secondary driven axle and an outer surface supporting a clutch inner race;
a carrier associated with and driven by the transmission, the carrier having an inner surface supporting a clutch outer race aligned with the clutch inner race, the clutch outer race having spaced apart ridges that define a series of roller pockets;
a plurality of rollers positioned in the respective roller pockets between the clutch inner and outer races; and
a cage rotationally supported between the clutch inner and outer races, the cage including a plurality of fingers extending between the clutch inner and outer races such that at least one finger extends between adjacent rollers;
wherein the second plate includes a projection that engages the carrier to selectively move the plurality of fingers and thereby shift the rollers within the respective roller pockets to achieve the first and second clutch positions.

13. The clutch assembly of claim 12, wherein the second plate includes a first friction pad engaging the first plate and a second friction pad engaging the clutch inner race.

14. The clutch assembly of claim 13, wherein the first and second friction pads are generally annular and have different diameters.

15. The clutch assembly of claim 12, wherein the second plate is sandwiched between the first plate and the clutch inner race.

16. A clutch assembly for a vehicle having at least one primary driven axle and at least one secondary driven axle, the at least one primary driven axle driven by a vehicle transmission, the clutch assembly comprising:
a drive sleeve having an inner surface engaging the secondary driven axle and an outer surface supporting a clutch inner race;
a carrier associated with and driven by the vehicle transmission, the carrier having an inner surface supporting a clutch outer race aligned with the clutch inner race, the clutch outer race having spaced apart inwardly extending ridges that define a series of roller pockets;
a plurality of rollers positioned in respective ones of the roller pockets between the clutch inner and outer races;
a cage rotationally supported between the clutch inner and outer races, the cage including a plurality of fingers extending between the clutch inner and outer races such that at least one finger extends between each pair of adjacent rollers;
a brake plate rotationally supported by the drive sleeve;
a solenoid armature configured to selectively engage and prevent rotation of the brake plate;
a friction plate rotationally supported by the drive sleeve and rotationally engaging the cage, the friction plate having a first friction pad of a first diameter engaging the clutch inner race and a second friction pad of a second diameter larger than the first diameter engaging the brake plate.

17. The clutch assembly of claim 16,
wherein the clutch assembly is coupled with a vehicle having at least one primary driven axle supporting a first wheel and at least one secondary driven axle supporting a second wheel, the at least one primary driven axle driven by a vehicle transmission; and
wherein the clutch assembly is in a first position when the solenoid armature prevents rotation of the brake plate, whereby the transmission engages the at least one secondary driven axle when the first wheel slips, and disengages the at least one secondary driven axle when the first wheel does not slip.

18. The clutch assembly of claim 17, wherein the clutch assembly is in a second position when the solenoid armature does not engage and prevent rotation of the brake plate, whereby the at least one secondary driven axle engages the transmission to provide engine braking.
